(19) United States
(12) Patent Application Publication
(10) Pub. No.: US 2009/0284099 A1
(43) Pub. Date: Nov. 19, 2009

(54) Electric rotary machine for vehicles

(75) Inventor: Harumi Horihata, Nagoya (JP)

Correspondence Address: OLIFF & BERRIDGE, PLC, P.O. BOX 320850, ALEXANDRIA, VA, 22320-4850, US

(73) Assignee: DENSO CORPORATION, Kariya-City (JP)

(21) Appl. No.: 12/453,430

(22) Filed: May 11, 2009

(30) Foreign Application Priority Data
May 14, 2008 (JP) 2008-126959

(51) Int. Cl. H01R 39/36

(52) U.S. Cl. 310/249

(57) ABSTRACT

An AC generator is provided with a rotor including a rotating shaft having a pair of collector rings, a pair of brushes, and a brush device having a brush holder that housing portions are formed where the pair of brushes is contained. The brush device is provided with a pair of field terminals that ends are connected to each of the brushes and other ends are connected to the control apparatus, fixing terminals, which is electrically insulated with the field terminals, that fix the brush holder, and a wall part that is formed integrally with the brush holder and is arranged between the pair of field terminals.

### CROSS-REFERENCE TO RELATED APPLICATION

This application is based on and claims the benefit of priority from earlier Japanese Patent Applications No. 2008-126959 filed on May 14, 2008, the description of which is incorporated herein by reference.

### BACKGROUND OF THE INVENTION

1. Technical Field of the Invention

This invention relates to an electric rotary machine for vehicles, such as an AC generator for vehicles equipped in a passenger car, a truck, etc., and a motor for generators.

2. Description of the Related Art

As shown in Japanese Patent Application Laid-Open Publication No. 2001-28857, for example, there is known an AC generator for vehicles that has a brush holder with a pair of terminals connected to the brush that is fixed to the brush holder, and has a negative pole side terminal that projects from the brush holder connected electrically to a frame by fixing thereto.

With this composition, since the terminal of the brush holder is electrically connected by directly fixing it to the frame, the brush holder is reliably fixed to the frame, while a reliable electric connection of the negative pole side can be obtained.

By the way, there is an AC generator for vehicles that controls the output torque to a rotor and/or an output power generated by a stator winding, by passing an exciting current that flows in a field winding of the rotor looped around for field generating and/or in the terminal connected to the brush in positive and negative directions so that a magneto motive force is controlled.

In such an AC generator, since the exciting current supplied to the field winding via the terminal of the brush holder is required to reverse the direction of current if desired, the composition disclosed in the above-mentioned publication can not be adopted, so that there will be a problem that fixing of the brush holder can not be ensured.

### SUMMARY OF THE INVENTION

The present invention has been made in order to solve the issue described above, and has as its object to provide an electric rotary machine for vehicles that can reliably fix a brush holder while being able to control directions of an exciting current if desired.

To solve the above-described issues, the electric rotary machine for vehicles of the present invention comprises a rotor containing a rotating shaft that has a pair of collector rings electrically connected with a field winding, a brush device, a pair of brushes that slidably contact to the collector rings, a brush holder formed with housing portions that contain the pair of brushes, and a control apparatus that controls an exciting current that flows to the field winding.

The brush device further comprises a pair of field terminals that ends are connected to each of the brushes and other ends are connected to the control apparatus, fixing terminals, which are electrically insulated from the field terminals, that fix the brush holder, and a wall part that is formed integrally with the brush holder and is arranged between the pair of field terminals.

Since the field terminals connected electrically to field windings are provided separately from the fixing terminals, it is possible to control the direction of the exciting current in the opposite direction if desired.

Further, providing the fixing terminals separately from the field terminals, the brush holder can be fixed reliably. Furthermore, since the wall part is formed between the pair of field terminals, a conductive substance intervenes between the field terminals will not be collected. Therefore, short circuits between the field terminals can be prevented, and their reliabilities are raised.

It is preferred that the wall part mentioned above is formed at right angles to an end surface of the brush holder in which the pair of field terminals are projected.

Further, it is preferred that a form of cross section of the wall part mentioned above is a nonlinear form.

Furthermore, it is preferred that a height of the wall part mentioned above is lower than a height of the terminal for field.

Moreover, it is preferred that a thickness of the wall part mentioned above becomes thinner as it goes to a tip.

Further, it is preferred that a height of the wall part mentioned above is not constant.

Furthermore, it is preferred that at least a part of the wall part mentioned above touches the field terminals.

### BRIEF DESCRIPTION OF THE DRAWINGS

In the accompanying drawings:

FIG. 1 shows a whole composition of an AC generator for vehicles according to an embodiment of the present invention;

FIG. 2 shows a figure of the AC generator for vehicles seen from its rear side;

FIG. 3 shows a sectional view of a brush holder;

FIG. 4 shows a plane view of the brush holder;

FIG. 5 shows a flow chart showing a manufacturing process of a brush;

FIG. 6A, FIG. 6B, and FIG. 6C show the modifications of wall parts integrally formed with the brush holders;

FIG. 7A, FIG. 7B, and FIG. 7C show the other modifications of wall parts integrally formed with the brush holders; and

FIG. 8A, FIG. 8B, and FIG. 8C show the other modifications of wall parts integrally formed with the brush holders.

### DETAILED DESCRIPTION OF THE PREFERRED EMBODIMENTS

Hereafter, an embodiment of an electric rotary machine for vehicles of the present invention applied to an AC generator for vehicles is explained in detail, referring to the drawings.

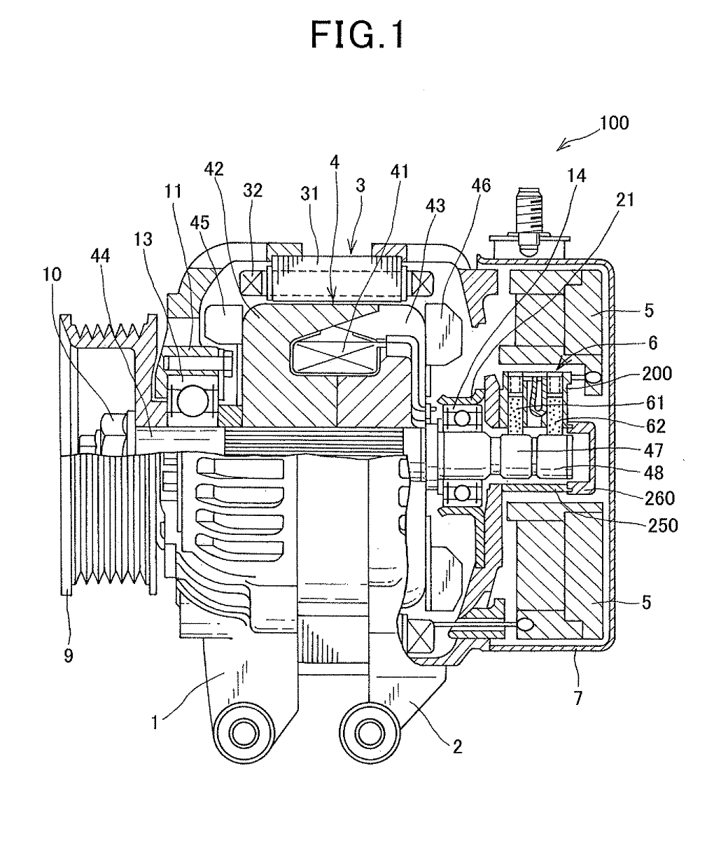

FIG. 1 is a partially sectional diagram of a whole composition of an AC generator for vehicles according to an embodiment.

The AC generator for vehicles 100 (hereinafter, shortened to “the AC generator 100”) shown in FIG. 1 is constituted including a front side frame 1, a rear side frame 2, a stator 3, a rotor 4, a control apparatus 5, a brush device 6, a rear cover 7, a pulley 9 and the like.

Both the front side frame 1 and the rear side frame 2 have bowl forms, and are mutually fixed with a plurality of bolts in the state where openings of the frames are facing each other and have the stator 3 therebetween.

There is formed a cylindrical bearing box 11 on the front side frame 1 integrally, and an iron-made bearing box 21 is attached to the rear side frame 2.

The stator 3 is provided with stator iron cores 31 and stator windings 32.

The rotor 4 has a field winding 41, pole cores 42 and 43, a rotating shaft 44 and the like, and is supported rotatably by a pair of bearings 13 and 14 arranged in the bearing boxes 11 and 21.

Cooling fans 45 and 46 are attached on end surfaces of the pole cores 42 and 43 in their axial directions.

The pulley 9 is fastened with the front end of the rotating shaft 44 with a nut 10, and driven by an engine of a vehicle (not shown).

In addition, a pair of collector rings 47 and 48 are formed on the rear end of the rotating shaft 44 that is located in the outside of the rear side frame 2. The collector rings 47 and 48 are connected to both ends of the field winding 41.

So-called electric parts such as the control apparatus 5, the brush device 6 and the like are fixed to an end surface of the outside of the rear side frame 2 in its axial direction by fixing means, such as a bolt.

The control apparatus 5 controls the output voltage of the AC generator 100 by controlling a direction and a size of an energization of an exciting current that flows to the field winding 41 while rectifies a three phase AC (alternating current) voltage that is an output voltage of the stator windings 32 and changes it into the DC (direct current) output voltage.

The brush device 6 is for passing the exciting current from the control apparatus 5 to the field winding 41 of the rotor 4, and is equipped with brushes 61 and 62 pressed to each of the collector rings 47 and 48 respectively, and formed on the rotating shaft 44 of the rotor 4.

These electric parts are covered with the rear cover 7.

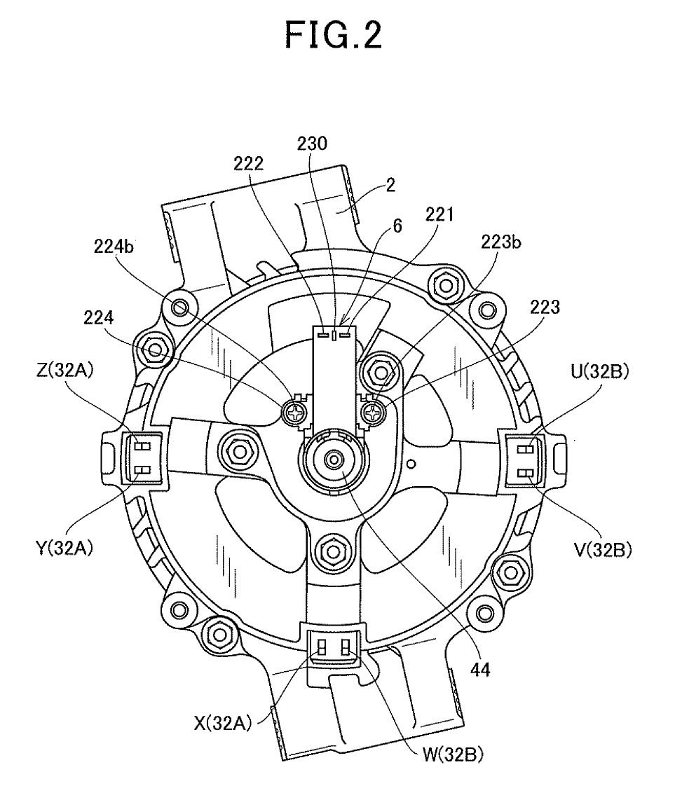

FIG. 2 is a view of the AC generator 100 seen from the rear side, and shows the exposed brush device 6 where the rear cover 7 and the control apparatus 5 are removed.

The stator windings 32 are consisting two sets of three phase windings 32A and 32B. Each end of the three phase windings 32A, X, Y, and Z, and each end of the other three phase windings 32B, U, V, and W is extended to the rear side through penetration holes (not shown) formed in the rear side frame 2. These ends are connected to the control apparatus 5.

Next, the detailed structure of the brush device 6 is explained. As shown in FIG. 1, the brush device 6 is constituted including a brush holder 200, the brushes 61 and 62, a collector ring cover 250, and a cover member 260.

A circumference space of the collector rings 47 and 48, which are equipped on the rotating shaft 44, is covered with the brush holder 200, the collector ring cover 250, and the cover member 260, and airtightness is secured by them.

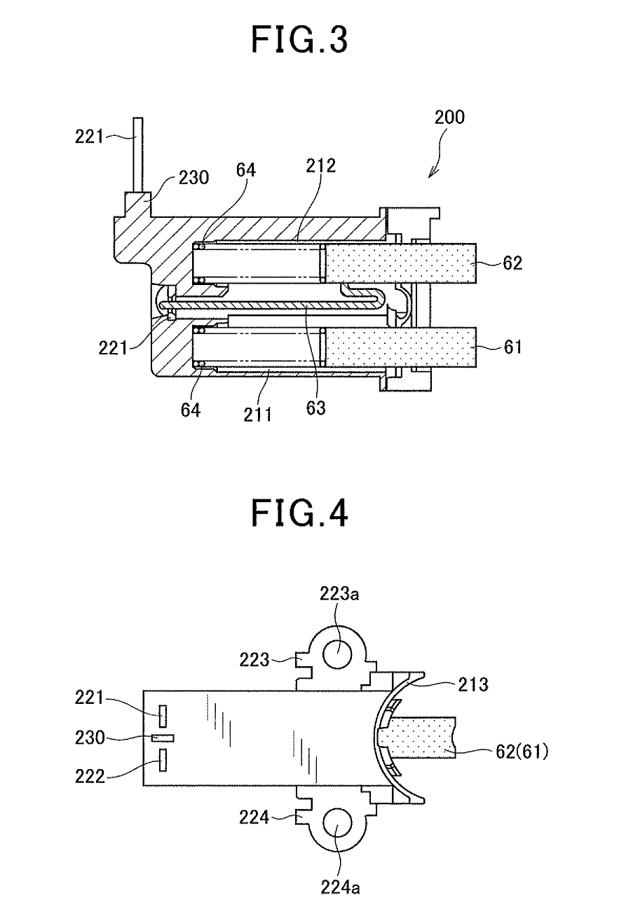

FIG. 3 is a sectional view of the brush holder 200, while FIG. 4 is a plane view of the brush holder 200.

The brush holder 200 has a box-like shape, and contains housing portions 211 and 212 with a rectangular parallelepiped shape, a skirt part 213, a pair of field terminals 221 and 222, and a pair of fixing terminals 223 and 224.

The housing portions 211 and 212 contain the brushes 61 and 62 respectively therein for the positive pole and the negative pole.

The skirt part 213 is extended while spreading from the housing portions 211 and 212 so that the collector rings 47 and 48 may be surrounded by the skirt part 213 at the time of assembling.

The field terminals 221 and 222 are electrically connected with pigtails 63 having flexibility as lead parts extending from each of the brushes 61 and 62, and are projected outwardly.

The fixing terminals 223 and 224 are insulated from the field terminals 221 and 222, and are projected outwardly.

The field terminals 221 and 222, and the fixing terminals 223 and 224 are inserted to the brush holder 200 that is made of insulated resin when molding.

The brushes 61 and 62 are metal graphite that contains copper powder in natural graphite and has phenol resin etc. as joint material.

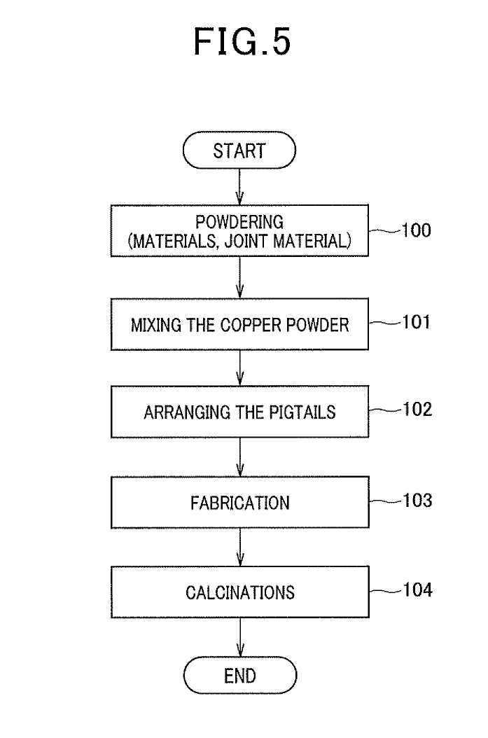

The manufacturing process shown in FIG. 5, for example, manufactures the brushes 61 and 62.

That is, the brushes 61 and 62 are manufactured by each of the following process: the process of powdering (Step 100) that mixes joint material (phenol resin) with materials (natural graphite), the process of mixing the copper powder (Step 101), the process of arranging the pigtails 63 (Step 102), the process of molding (Step 103), and the process of calcinations (Step 104).

The brushes 61 and 62 have the same forms, and contained in the housing portions 211 and 212. The same formed brushes 61 and 62 are arranged so that the pigtail 63 side of the brushes 61 and 62 may face mutually, and springs 64 are intervened between the brushes 61 and 62 and the housing portions 211 and 212. The brushes 61 and 62 are pressed towards the collector rings 47 and 48 by the springs 64, and slidably contact the collector rings 47 and 48 within the housing portions 211 and 212.

As shown in FIG. 4, the fixing terminals 223 and 224 are projected in the shape of an ear respectively from the sides of the brush holder 200 that counter each other, and holes 223a and 224a are formed in the center of those exposed parts.

The brush holder 200 is fixed to the rear side frame 2 by having screws 223b and 224b (refer to FIG. 2) as a fastening means pass through the each holes 223a and 224a, and fastening to bases (not shown) provided in an end surface of the rear side frame 2 in its axial direction.

As shown in FIGS. 3 and 4, the field terminals 221 and 222 are projected from the end surface of the brush holder 200 in its axial direction to the rear side (opposite side to the pulley 9 side at the time of assembling), so that the field terminals 221 and 222 may project parallel to the rotating shaft 44, and a wall part 230 formed integrally with the brush holder 200 is arranged between the field terminals 221 and 222.

The wall part 230 is formed at right angles to the end surface of the brush holder 200 in which the pair of field terminals 221 and 222 are projected.

In addition, the height of the wall part 230 is set lower than the height of the field terminals 221 and 222.

Thus, in the AC generator 100 of the present embodiment, since the field terminals 221 and 222 connected electrically to field winding 41 are provided separately from the fixing terminals 223 and 224, it is possible for the control apparatus 5 to control the direction of the exciting current in the opposite direction if desired.

Further, providing the fixing terminals 223 and 224 separately from the field terminals 221 and 222, the brush holder 200 can be fixed reliably to the rear side frame 2.

Furthermore, since the wall part 230 is formed between the pair of field terminals 221 and 222, a conductive substance intervenes between the field terminals 221 and 222 will not be collected. Therefore, short circuits between the field terminals 221 and 222 can be prevented, and raise their reliabilities.

Moreover, by forming the wall part 230 at right angles to the end surface of the brush holder 200 in which the field terminals 221 and 222 are projected, a conductive substance becomes difficult to accumulate along with the wall part 230, thus reliable insulation between the field terminals 221 and 222 is secured.

Further, by setting the height of the wall part 230 lower than the height of the field terminals 221 and 222, electric connections to the end of the field terminals 221 and 222 become easy.

It should be appreciated that the present invention can also be applied to a generator with a structure having a rotor driven by a revolving magnetic field generated by a stator.

It should also be appreciated that present invention is not limited to the above-mentioned embodiment, and various modification implementations are possible for it within the limits of the summary of this invention.

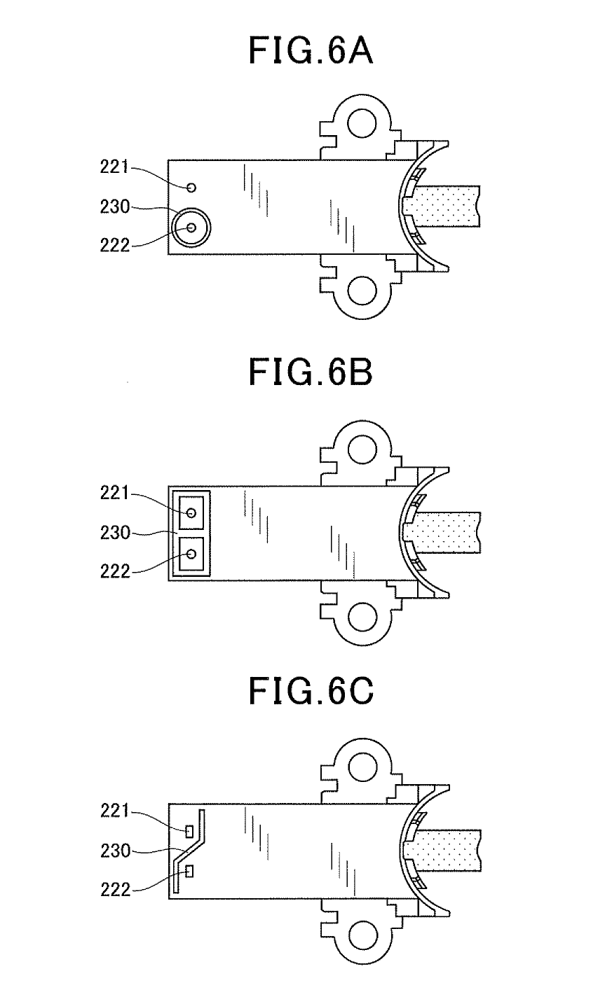

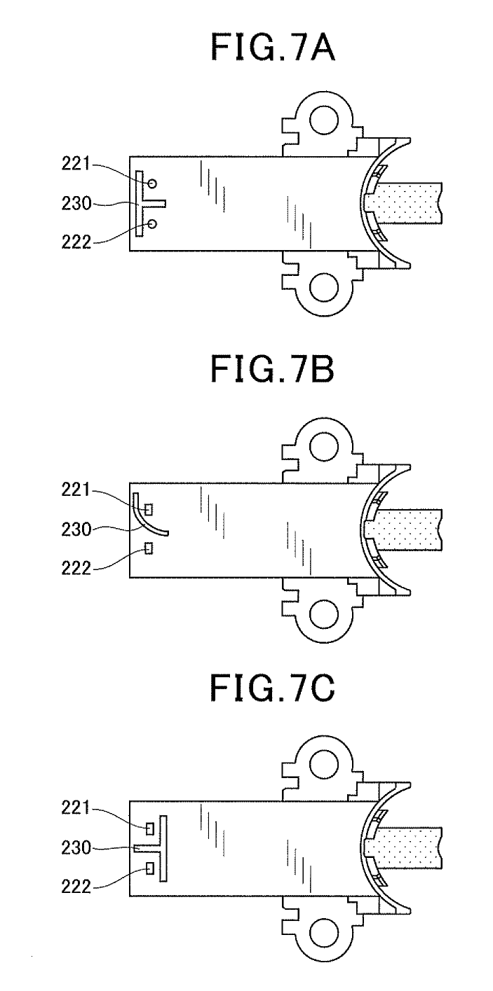

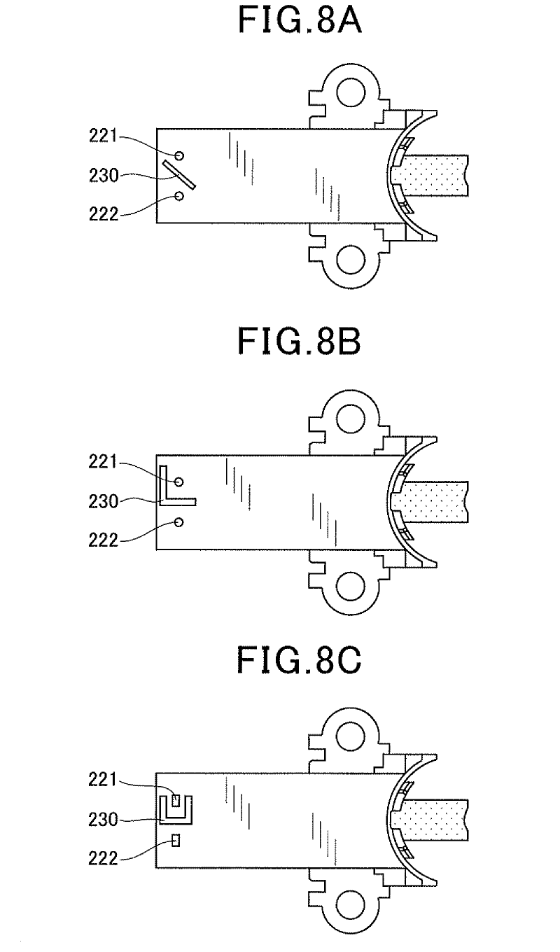

FIG. 6A, FIG. 6B, FIG. 6C, FIG. 7A, FIG. 7B, FIG. 8A, FIG. 8B, and FIG. 8C show modifications of wall parts formed integrally with the brush holders 200. The modifications shown below are shown in these drawings.

(1) Surround a terminal for field 222 in a circular wall part 230 (FIG. 6A).

(2) Surround two field terminals 221 and 222 in the rectangular wall part 230 separately (FIG. 6B).

(3) Form a wall part 230 aslant between two field terminals 221 and 222, and consider the wall part 230 as a nonlinear form where the both ends are further extended along the field terminals 221 and 222 (FIG. 6C).

(4) Form a T-shaped wall part 230 between two field terminals 221 and 222 (FIG. 7A and FIG. 7C)

(5) Form a circle type wall part 230 in the circumference of one terminal for field 221 (FIG. 7B).

(6) Form a wall part 230 aslant between two field terminals 221 and 222 (FIG. 8A).

(7) Form an L-shaped wall part 230 in the circumference of one terminal for field 221 (FIG. 8B).

(8) Form a C-shaped wall part 230 in the circumference of one terminal for field 221 (FIG. 8C).

The strength of the wall part 230 can be increased by making the form of cross sections of the wall part 230 into nonlinear form (excluding the form of FIG. 8A).

In addition, modifications other than the above are:

(A) Make a thickness of a wall part 230 thinner as it goes to a tip.

(B) Make a height of a wall part 230 not constant, but with a vertical interval.

(C) Make no space between a wall part 230 and field terminals 221 and 222, but at least a part of the wall part 230 touches either/both of the field terminals 221 and 222.

In the modification (A), a conductive substance becomes difficult to accumulate with the wall part 230, thus reliable insulation between the field terminals 221 and 222 is secured.

In the modification (B), a cooling air can be passed through a portion with the low height at the wall part 230 tip, and cooling properties can be secured.

In the modification (C), deformation of the field terminals 221 and 222 that are in contact with the wall part 230 can be prevented.

What is claimed is:

1. An electric rotary machine for vehicles comprising:
a rotor containing a rotating shaft that has a pair of collector rings electrically connected with a field winding;
a brush device;
a pair of brushes that slidably contact to the collector rings;
a brush holder formed with housing portions that contain the pair of brushes; and
a control apparatus that controls an exciting current that flows to the field winding;
wherein, the brush device further comprising:
a pair of field terminals that ends are connected to each of the brushes and other ends are connected to the control apparatus;
fixing terminals, which are electrically insulated with the field terminals, that fix the brush holder; and
a wall part that is formed integrally with the brush holder and is arranged between the pair of field terminals.

2. The electric rotary machine for vehicles according to claim 1,
wherein, the wall part is formed at right angles to an end surface of the brush holder in which the pair of field terminals are projected.

3. The electric rotary machine for vehicles according to claim 1,
wherein, a form of a cross section of the wall part is a nonlinear form.

4. The electric rotary machine for vehicles according to claim 1,
wherein, a height of the wall part is lower than a height of the terminal for field.

5. The electric rotary machine for vehicles according to claim 1,
wherein, a thickness of the wall part becomes thinner as it goes to a tip.

6. The electric rotary machine for vehicles according to claim 1,
wherein, a height of the wall part is not constant.

7. The electric rotary machine for vehicles according to claim 1, wherein, at least a part of the wall part touches the field terminals.
